(19) United States
(12) Patent Application Publication
(10) Pub. No.: US 2026/0045790 A1
(43) Pub. Date: Feb. 12, 2026

(54) SYSTEM AND METHOD FOR UTILIZING EXCESS GENERATED OR SUPPLIED ELECTRICAL POWER TO AN ELECTRICAL STORAGE DEVICE FOR POWERING AN ELECTRICAL ENERGY CONSUMING DEVICE

(71) Applicant: David A. Deeks, Sidney, British Columbia (CA)

(72) Inventor: David A. Deeks, Sidney, British Columbia (CA)

(21) Appl. No.: 19/291,381

(22) Filed: Aug. 5, 2025

Related U.S. Application Data
(60) Provisional application No. 63/680,044, filed on Aug. 6, 2024.

(51) Int. Cl. H02J 1/08

(52) U.S. Cl. CPC H02J 1/082; H02J 2300/24; H02J 2310/40

(57) ABSTRACT

Described are various embodiments of a system and method for utilizing excess generated or supplied electrical power from an electrical storage device for powering an electrical energy consuming device.

### CROSS REFERENCE TO RELATED APPLICATION

This application claims priority to U.S. Provisional Patent Application No. 63/680,044, filed Aug. 6, 2024, and entitled “SYSTEM AND METHOD FOR UTILIZING EXCESS GENERATED OR SUPPLIED ELECTRICAL POWER TO AN ELECTRICAL STORAGE DEVICE FOR POWERING AN ELECTRICAL ENERGY CONSUMING DEVICE,” the entire disclosure of which is hereby incorporated herein by reference.

### FIELD OF THE DISCLOSURE

The present disclosure relates to the use of excess generated or supplied electrical power to an electrical power storage device, and, in particular, to a system and method for utilizing excess generated or supplied electrical power to an electrical storage device for an electrical energy consuming device.

### BACKGROUND

Certain applications, such as recreational vehicles (RV's) or boats, require electrical power to power systems and equipment. These systems may require electrical power to be directly supplied or the electrical power to supplied to an electrical storage device, such as a battery.

A hard-line power supply from a power grid coupled to, for example, and an RV or a boat (i.e., shore power), is not always available, and therefore solar panel systems have been developed to supply electrical power, generally to keep a battery supplied. However, currently available solar panel systems for certain applications are not always capable of supplying the often-required power demand due to the amount of solar panel surface area exposed to the sun. Furthermore, in some applications, such as RV's, boats or other transportation-based devices, there is limited surface on the vehicle to mount the required number of solar panels to meet the power demands. Also, due to vehicles moving from one location to another, having a large number of solar panels laid out to generate the required amount of electrical power may not be practical for transport or movement of the vehicle. Indeed, although some solar panel arrangements rely on extendable solar panel arrangements to meet power demands, these arrangements typically require complex assembly and are therefore time-consuming to assemble and/or disassemble.

International Patent Application Serial Number: PCT/CA2023/051132, filed Aug. 27, 2023, and entitled “EXPANDABLE SOLAR PANEL ARRAY SYSTEM AND KITS FOR SAME” describes a nestable solar panel array system which is expandable to increase the surface area and number of solar panels which are exposed to the sun in order to generate electrical power from the photo-voltaic solar cells. The solar panel array is expandable for capturing a maximum amount of solar energy available to the photo-voltaic solar cells and collapsable for transport and/or to decrease the amount of photo-voltaic solar cells exposed to the sun.

In systems such as the one described in International Patent Application SN: PCT/CA2023/051132, the generated electrical power can be fed to one or more batteries where the generated electrical power can be stored. Other systems, such as trickle-chargers and other batter charging devices are also known which fed electrical power to batteries for storage. However, once the batteries are charged, the excess generated or supplied electrical power to the batteries is lost since the batteries coupled to a given system have a finite power storage capacity. The batteries thus cannot store any additional power beyond their maximum capacity until at least some of the stored power is used and the used power replaced as generated from the photo-voltaic solar cells of the solar panels or supplied to the batteries from another source.

This background information is provided to reveal information believed by the applicant to be of possible relevance. No admission is necessarily intended, nor should be construed, that any of the preceding information constitutes prior art or forms part of the general common knowledge in the relevant art.

### SUMMARY

The following presents a simplified summary of the general inventive concept(s) described herein to provide a basic understanding of some aspects of the disclosure. This summary is not an extensive overview of the disclosure. It is not intended to restrict key or critical elements of embodiments of the disclosure or to delineate their scope beyond that which is explicitly or implicitly described by the following description and claims.

A need exists for a system for utilizing excess generated or supplied electrical power to an electrical storage device for powering an electrical energy consuming device that overcomes some of the drawbacks of known techniques, or at least, provides a useful alternative thereto. Some aspects of this disclosure provide examples of such a system for selectively routing electrical power from a supplied electrical power source.

In accordance with one aspect, there is provided a system for selectively routing electrical power from a supplied electrical power source. The system comprises an electrical power source in selectable electrical communication with an electrical power storage device and one or more electrical energy consuming devices. A programmable software module is provided, which comprises a processor and computer-readable medium capable of storing and executing instructions thereon for controlling an electrical power relay. The programmable software module is configured for receiving information pertaining to the amount electrical power stored in the electrical power storage device and executing the instructions via the processer to control the electrical power relay for selectively supplying the electrical power to the one or more electrical energy consuming devices.

In some embodiments, the programmable software module is configured for closing the electrical relay so as to provide electrical power to the one or more electrical energy consuming devices once a predefined amount of electrical power has been stored in the electrical power storage device.

In some embodiments, once the predefined amount of electrical power has been stored in the electrical power storage device, the programmable software module is configured to automatically execute the instructions to close the power relay and supply electrical power to the one or more electrical energy consuming devices.

In some embodiments, the programmable software module is configured to accept user input to execute the instructions to close the power relay and supply electrical power to the one or more electrical energy consuming devices.

In some embodiments, the one or more electrical energy consuming devices, is at least one of a heating element, a secondary or more electrical power storage devices, a cooling element, a fan, or combination thereof.

In some embodiments, the system further comprises a user information and control center for at least one of monitoring the electrical power supplied from the electrical power source, the amount of electrical power stored in the electrical power storage device, the amount of electrical power used by the one or more electrical energy consuming devices, control parameters and functions of the one or more electrical energy consuming devices, and user-selectively controlling the electrical relay.

In some embodiments, the system further comprises a light sensor operatively coupled to the programmable software module for sensing available light; the programmable software module configured for opening and closing the electrical relay based at least in part on the intensity of the sensed light.

In another aspect, there is provided a method for utilizing excess generated or supplied electrical power comprising, providing a system as defined herein and causing electrical power to be provided to the one or more electrical energy consuming devices once a predefined or desired amount of electrical power has been stored in the electrical power storage device.

Other aspects, features and/or advantages will become more apparent upon reading of the following non-restrictive description of specific embodiments thereof, given by way of example only with reference to the accompanying drawings.

### BRIEF DESCRIPTION OF THE FIGURES

Several embodiments of the present disclosure will be provided, by way of examples only, with reference to the appended drawings, wherein:

FIG. 1 is a schematic diagram of a system for utilizing excess generated or supplied electrical power supplied to an electrical storage device for powering an electrical energy consuming device showing current flow to an electrical storage device;

FIG. 2 is a schematic diagram of the system of FIG. 1 showing electrical current flow to an electrical power consuming device;

FIG. 3 is a schematic diagram showing an alternative arrangement of the system of FIGS. 1 and 2; and

FIG. 4 is a schematic diagram of an arrangement of a user information and control center 22 of FIGS. 1, 2, and 3.

Elements in the several figures are illustrated for simplicity and clarity and have not necessarily been drawn to scale. For example, the dimensions of some of the elements in the figures may be emphasized relative to other elements for facilitating understanding of the various presently disclosed embodiments. Also, common, but well-understood elements that are useful or necessary in commercially feasible embodiments are often not depicted in order to facilitate a less obstructed view of these various embodiments of the present disclosure.

### DETAILED DESCRIPTION

Various implementations and aspects of the specification will be described with reference to details discussed below. The following description and drawings are illustrative of the specification and are not to be construed as limiting the specification. Numerous specific details are described to provide a thorough understanding of various implementations of the present specification. However, in certain instances, well-known or conventional details are not described in order to provide a concise discussion of implementations of the present specification.

Various apparatuses and processes will be described below to provide examples of implementations of the system disclosed herein. No implementation described below limits any claimed implementation and any claimed implementations may cover processes or apparatuses that differ from those described below. The claimed implementations are not limited to apparatuses or processes having all of the features of any one apparatus or process described below or to features common to multiple or all of the apparatuses or processes described below. It is possible that an apparatus or process described below is not an implementation of any claimed subject matter.

Furthermore, numerous specific details are set forth in order to provide a thorough understanding of the implementations described herein. However, it will be understood by those skilled in the relevant arts that the implementations described herein may be practiced without these specific details. In other instances, well-known methods, procedures and components have not been described in detail so as not to obscure the implementations described herein.

In this specification, elements may be described as “configured to” perform one or more functions or “configured for” such functions. In general, an element that is configured to perform or configured for performing a function is enabled to perform the function, or is suitable for performing the function, or is adapted to perform the function, or is operable to perform the function, or is otherwise capable of performing the function.

It is understood that for the purpose of this specification, language of “at least one of X, Y, and Z” and “one or more of X, Y and Z” may be construed as X only, Y only, Z only, or any combination of two or more items X, Y, and Z (e.g., XYZ, XY, YZ, ZZ, and the like). Similar logic may be applied for two or more items in any occurrence of “at least one . . . ” and “one or more . . . ” language.

Unless defined otherwise, all technical and scientific terms used herein have the same meaning as commonly understood by one of ordinary skill in the art to which this invention belongs.

Throughout the specification and claims, the following terms take the meanings explicitly associated herein, unless the context clearly dictates otherwise. The phrase “in one of the embodiments” or “in at least one of the various embodiments” as used herein does not necessarily refer to the same embodiment, though it may. Furthermore, the phrase “in another embodiment” or “in some embodiments” as used herein does not necessarily refer to a different embodiment, although it may. Thus, as described below, various embodiments may be readily combined, without departing from the scope or spirit of the innovations disclosed herein.

In addition, as used herein, the term “or” is an inclusive “or” operator, and is equivalent to the term “and/or,” unless the context clearly dictates otherwise. The term “based on” is not exclusive and allows for being based on additional factors not described, unless the context clearly dictates otherwise. In addition, throughout the specification, the meaning of “a,” “an,” and “the” include plural references. The meaning of “in” includes “in” and “on.”

As used in the specification and claims, the singular forms “a”, “an” and “the” include plural references unless the context clearly dictates otherwise.

The term “comprising” as used herein will be understood to mean that the list following is non-exhaustive and may or may not include any other additional suitable items, for example one or more further feature(s), component(s) and/or element(s) as appropriate.

The systems and methods described herein provide, in accordance with different embodiments, different examples which provide a system for diverting excess electrical power generated from photo-voltaic solar cells of solar panels or other sources in electrical communication with storage batteries to another power consuming or storage device.

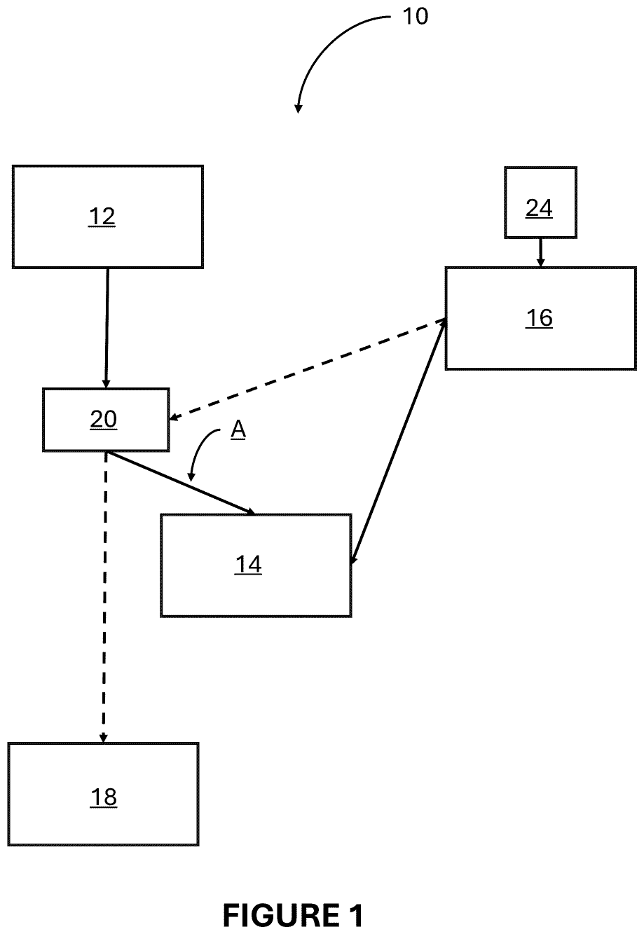

With reference to FIG. 1, and in accordance with one exemplary embodiment, a system for diverting excess electrical power generated from photo-voltaic solar cells of solar panels or other sources in electrical communication with storage batteries to another power consuming or storage device, is generally referred to using the numeral 10, will now be described.

Briefly, the system 10 is coupled for electrical communication to an electrical power source 12, such as one or more solar cells or another electrical power suppling source, which supplies electrical power for storage to one or more batteries or electrical power storage device(s) 14. The amount of electrical power stored in the electrical power storage device 14 is monitored by a programmable software module 16. The programmable software module 16 is configured to automatically divert electrical power from the electrical power source 12 to an electrical energy consuming device 18 once the electrical power storage device 14 is charged to a pre-defined level. In some embodiments, the programmable software module 16 may be configured to divert electrical power from the electrical power source 12 to the electrical power storage device 14 to an electrical energy consuming device 18 on demand by a user, thus circumventing the electrical power storage device 14.

The programmable software module 16, as may be known in the art, includes a processor and computer-readable medium capable of storing and executing instructions thereon to automatically, based on information received from the electrical power storage device 14 control an electrical relay 20. For example, if the maximum or desired amount of electrical power is stored in the electrical power storage device 14 is reached, the programmable software module 16 automatically processes this information and executes functions to close the electrical relay 20 so as to divert excess generated or supplied electrical power to the electrical energy consuming device 18 such that it is not wasted. The programmable software module 16 may also include instructions executable on a user's demand to control the electrical relay 20.

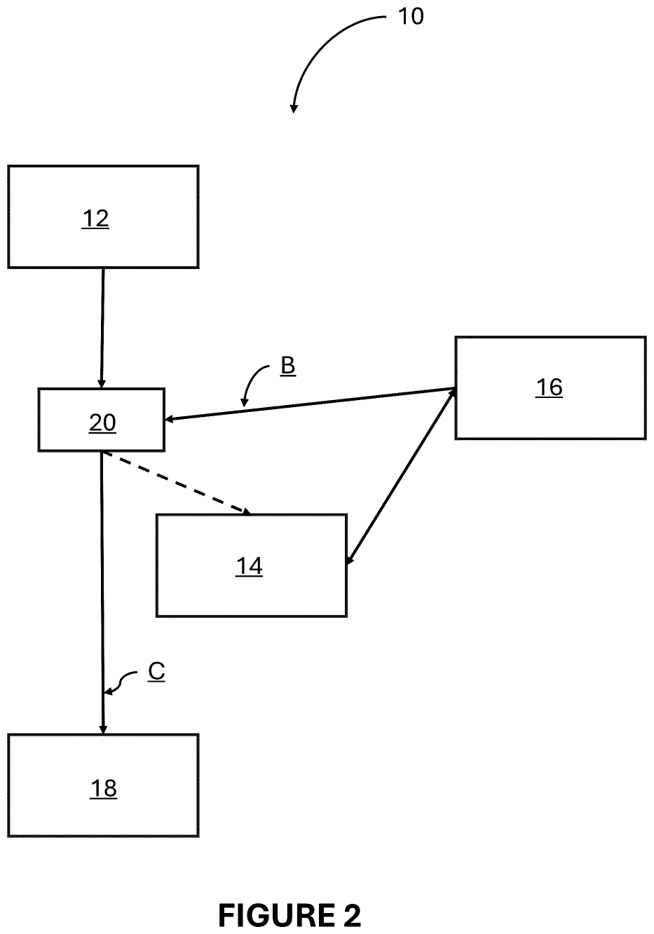

In some embodiments, the programmable software module 16 may be configured to automatically divert electrical power from electrical power storage device 14 prior to the maximum electrical power storage capacity being reached. For example, a 12V automotive battery generally has a maximum storage capacity of about 14.1V. In such a case, once the amount of electrical power stored in the electrical power storage device 14 reaches 14.1V, the programmable software module 16 cause the electrical relay 20 to close such that electrical power source 12 is no longer supplying electrical power to the electrical power storage device 14, but rather to the electrical energy consuming device 18, as shown in FIG. 2.

With regard to FIG. 1, electrical power from the electrical power source 12 is provided to the electrical power storage device 14 as shown schematically at A, via the electrical relay 20, and the amount of electrical power stored in the electrical power storage device 14 is monitored by programmable software module 16. Once the desired amount of electrical power stored in the electrical power storage device 14 is reached, the programmable software module 16 causes the electrical relay 20 to close as shown schematically at B, and electrical power to thus be supplied to the electrical energy consuming device 18, as shown schematically at C in FIG. 2 and indicated by the solid arrows. As noted above, in some embodiments the programmable software module 16 may be caused by a user to divert electrical power from the electrical power storage device 14 to the electrical energy consuming device 18 on demand, prior to the desire level of power stored in the electrical power storage device 14 being reached.

In various embodiments, for example, the electrical energy consuming device 18 may be a heating element coupled or installed in a hot water tank (not shown). Thus, once the maximum electrical storage capacity (or programmed desired level of stored electrical power) has been reached in the electrical power storage device 14, the programmable software module 16 causes the electrical relay 20 to close thus supplying electrical power to the heating element 18, which in turn heats water stored a hot water tank. Accordingly, in this regard, once the maximum electrical storage capacity of the electrical power storage device 14 has been reached, excess generated or supplied electrical power is not wasted due to the electrical power storage device 14 not being capable of storing more. But rather the excess generated or supplied electrical power is utilized for powering another electrical energy consuming device 18. In various embodiments the electrical energy consuming device 18 may be at least one of a heating element, a secondary or more electrical power storage devices, a cooling element, a fan, or combination thereof. Other such electrical energy consuming devices will be apparent to those of skill in the art.

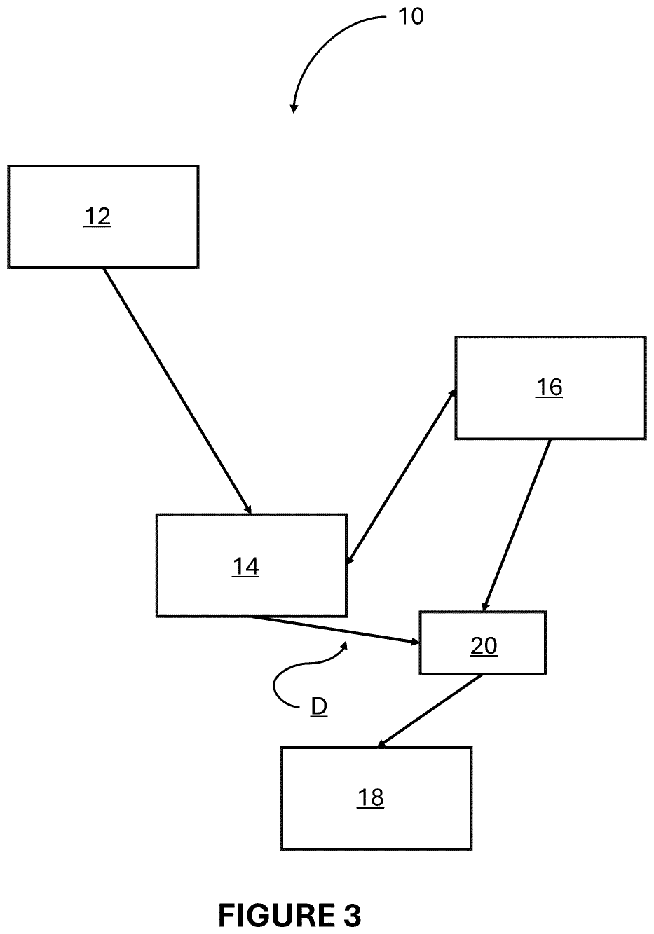

In an alternative embodiment, such as the one shown in FIG. 3, the programmable software module 16 continues, as in other embodiments to monitor the electrical power stored in the electrical power storage device 14. The electrical power source 12 supplies generated or supplied electrical power to the electrical power storage device 14. Once the maximum electrical storage capacity of the electrical power storage device 14 has been reached, the programmable software module 16 causes the electrical relay 20 as shown at D to close and thus excess electrical power is supplied to another electrical energy consuming device 18 from the electrical power storage device 14 and replenished from the electrical power source 12. The open electrical relay 20 current flow path is not shown in the figures for simplicity—in such as case the arrow at D would be shown as a hashed arrow.

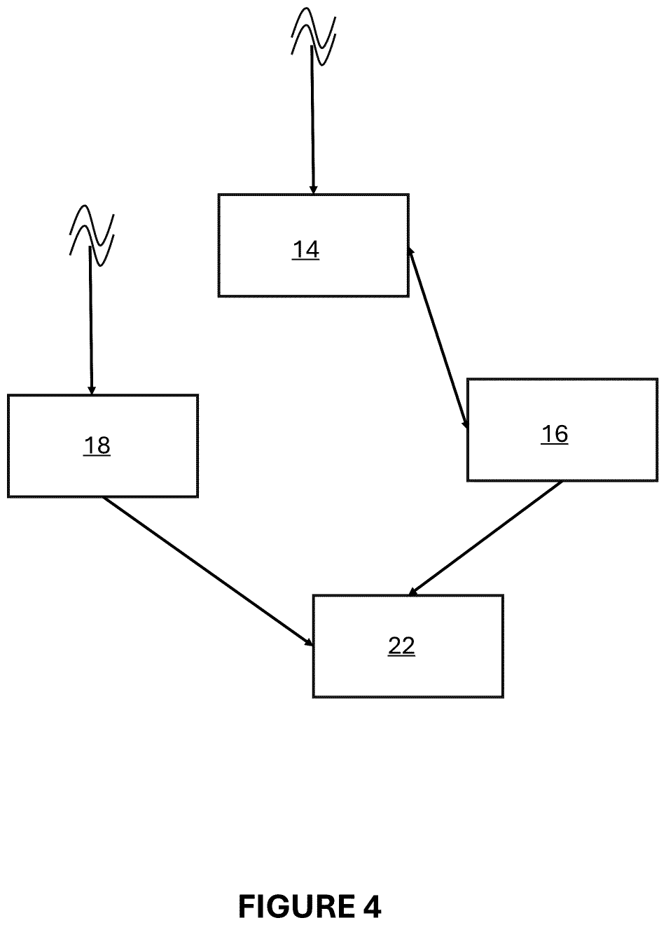

In some embodiments, as shown schematically in FIG. 4, the programmable software module 16 may be coupled to an information display and/or relay control device 22, also termed herein as a user information and control center 22. The electrical energy consuming device 18 may also be coupled to the user information and control center 22 directly, as shown schematically in FIG. 4, or via the programmable software module 16 (not shown). The user information and control center 22 can provide a user with information such as the amount of electrical energy stored in the electrical power storage device 14 and parameters and information pertaining to the energy use of the electrical energy consuming device 18. For example, in the case of the electrical energy consuming device 18 being a heating element of a hot water tank, the temperature of the water in the hot water tank via coupled thermostat (not shown), allowance for user control of the heating element 18, and/or user control of the electrical relay 20 to divert electrical to or from the electrical power storage device 14 to the electrical energy consuming device 18 and may be shown and controlled by information and control center 22. Thus, the information and control center 22 may comprise a controllable thermostat.

In some embodiments there may also be provided a light senor as schematically shown at 24 in FIG. 1 for sensing if the amount of light available to the photo-voltaic cells of the solar panel(s) 12 has diminished or increased. The light sensor 24 may provide information to the programmable software module 16 to open or close the electrical power relay 20 thus adjusting electrical power supplied to the electrical energy consuming device 18 based on the amount of light sensed so as to maintain the stored electrical energy level in the electrical power storage device 14.

While the present disclosure describes various embodiments for illustrative purposes, such description is not intended to be limited to such embodiments. On the contrary, the applicant's teachings described and illustrated herein encompass various alternatives, modifications, and equivalents, without departing from the embodiments, the general scope of which is defined in the appended claims. Except to the extent necessary or inherent in the processes themselves, no particular order to steps or stages of methods or processes described in this disclosure is intended or implied. In many cases the order of process steps may be varied without changing the purpose, effect, or import of the methods described.

Information as herein shown and described in detail is fully capable of attaining the above-described object of the present disclosure, the presently preferred embodiment of the present disclosure, and is, thus, representative of the subject matter which is broadly contemplated by the present disclosure. The scope of the present disclosure fully encompasses other embodiments which may become apparent to those skilled in the art, and is to be limited, accordingly, by nothing other than the appended claims, wherein any reference to an element being made in the singular is not intended to mean “one and only one” unless explicitly so stated, but rather “one or more.” All structural and functional equivalents to the elements of the above-described preferred embodiment and additional embodiments as regarded by those of ordinary skill in the art are hereby expressly incorporated by reference and are intended to be encompassed by the present claims. Moreover, no requirement exists for a system or method to address each and every problem sought to be resolved by the present disclosure, for such to be encompassed by the present claims. Furthermore, no element, component, or method step in the present disclosure is intended to be dedicated to the public regardless of whether the element, component, or method step is explicitly recited in the claims. However, that various changes and modifications in form, material, work-piece, and fabrication material detail may be made, without departing from the spirit and scope of the present disclosure, as set forth in the appended claims, as may be apparent to those of ordinary skill in the art, are also encompassed by the disclosure.

What is claimed is:

1. A system for selectively routing electrical power from a supplied electrical power source, the system comprising:
an electrical power source in selectable electrical communication with an electrical power storage device and one or more electrical energy consuming devices; and
a programmable software module comprising a processor and computer-readable medium capable of storing and executing instructions thereon for controlling an electrical power relay;
the programmable software module configured to receive information pertaining to an amount of electrical power stored in the electrical power storage device and executing the instructions via the processor to control the electrical power relay for selectively supplying the electrical power to the one or more electrical energy consuming devices.

2. The system of claim 1, wherein the programmable software module is configured to close the electrical power relay so as to provide electrical power to the one or more electrical energy consuming devices once a predefined amount of electrical power has been stored in the electrical power storage device.

3. The system of claim 1, wherein once a predefined amount of electrical power has been stored in the electrical power storage device, the programmable software module is configured to automatically execute the instructions to close the electrical power relay and supply electrical power to the one or more electrical energy consuming devices.

4. The system of claim 1, wherein the programmable software module is configured to accept user input to execute the instructions to close the electrical power relay and supply electrical power to the one or more electrical energy consuming devices.

5. The system of claim 1, wherein the one or more electrical energy consuming devices comprises at least one of a heating element, a secondary or more electrical power storage devices, a cooling element, a fan, or combination thereof.

6. The system of claim 1, further comprising user information and control center for at least one of monitoring the electrical power supplied from the electrical power source, the amount of electrical power stored in the electrical power storage device, the amount of electrical power used by the one or more electrical energy consuming devices, control parameters and functions of the one or more electrical energy consuming devices, and user-selectively controlling the electrical power relay.

7. The system of claim 1, further comprising a light sensor operatively coupled to the programmable software module and configured to sense available light, wherein the programmable software module is configured to open and close the electrical power relay based at least in part on an intensity of light sensed by the light sensor.

8. A method for utilizing excess generated or supplied electrical power comprising:
providing a system of claim 1; and
causing electrical power to be provided to the one or more electrical energy consuming devices once a predefined or desired amount of electrical power has been stored in the electrical power storage device.
